(19) United States
(12) Patent Application Publication
(10) Pub. No.: US 2022/0404145 A1
(43) Pub. Date: Dec. 22, 2022

(54) Silent, Adjustable, Hands Free Display Activation Apparatus and Method for Optical Viewing

(71) Applicant: Back Mountain Outdoor Products, Inc., Dallas, PA (US)

(72) Inventor: Michael Castner, Dallas, PA (US)

(21) Appl. No.: 17/355,107

(22) Filed: Jun. 22, 2021

(51) Int. Cl. G01C 3/02; G01S 19/01; H04N 7/18; H04N 5/84

(52) U.S. Cl. CPC G01C 3/02; G01S 19/01; H04N 7/18; H04N 5/84

(57) ABSTRACT

An improved silent, adjustable, hands free optical viewing device that allows a hunter to obtain real time ranges to a target or an enhanced view of a target with a minimum of noise and motion. A variation allows the mounting of a video camera to capture video of the hunt.

### CROSS REFERENCE TO RELATED APPLICATIONS

None

### FEDERAL RESEARCH STATEMENT

None

### BACKGROUND OF THE INVENTION

This improved invention relates to a silent, adjustable, hands free display activation apparatus and method for optical viewing with optional video capability that allows a hunter to obtain the range to a target while maintaining a bow or rifle in a position ready to shoot. The present invention also allows for a hunter to record a video of his or her hunt. The present invention allows for mounting on either shoulder to accommodate either a left-handed or right-handed hunter.

### DESCRIPTION OF THE PRIOR ART

There are innumerable optical viewing devices on the market. However, each of these optical viewing devices requires that the hunter put down the bow or rifle in order to obtain the distance to the target or an enhanced view of the target. Inherent in any such movement is a certain amount of noise. As any hunter knows, such motion and accompanying noise frequently distracts the target and often causes the target to run away. In light of this, there is a need for a silent, adjustable, hands free range finder that is attached to a hunter's body (preferably the hunter's shoulder) that enables a hunter to obtain a distance to the target with virtually no discernable motion or noise.

### SUMMARY OF THE INVENTION

The present invention is directed toward a silent, adjustable, hands free display activation apparatus and method for optical viewing combined with a shoulder mounting apparatus that allows a hunter to quietly and with a minimum of discernable motion and associated noise to determine an accurate and timely range to a target. In its best mode, the silent, adjustable, hands free silent, adjustable, hands free display activation apparatus (hereinafter referred to as an “integrated range finder” for brevity) is mounted on either shoulder by a mounting strap or similar device. The silent, digital, adjustable, hands free range finder is positioned on the shoulder such that it can be quickly and quietly flipped upright and be in position to be readily viewed when the hunter is ready to shoot. An additional feature of this device is that there is an optional on/off continuous scan switch which allows the hunter to receive instantaneous and continuous updates of the range to the target. The on/off switch allows the hunter to conserve battery life. The on/off switch has the additional feature that once activated, the scan stays on until it is deactivated. As an alternative, the device can be programmed to automatically go off after a certain period of time. This feature can be either mechanical or electronic. In addition, there is a capability to have a video recorder incorporated into the apparatus.

### BRIEF DESCRIPTION OF DRAWINGS

FIG. 1 shows a side view of the hunter looking through the silent, digital, adjustable, hands free silent, adjustable, hands free display activation apparatus Display Activation Apparatus and Method for Optical Viewing (integrated range finder) and associated shoulder attachment apparatus that allows the hunter to affix the silent, adjustable, hands free range finder to either shoulder. The silent, digital, adjustable, hands free Display Activation Apparatus and Method for Optical Viewing is comprised of a range finder, a shoulder mounting apparatus, and a series of straps that hold the shoulder mounting apparatus on a hunter's shoulder. This view shows the range finder in the upright position. Note that while this application focuses on use of an electronic range finder, a video recording device, high definition camera, infrared camera, or any other similar device can be mounted on or attached to the apparatus.

FIG. 2 shows a front view of the hunter with his head turned between 60 to 90 degrees to the left to look through the range finder. The entire apparatus is very light and compact and will not add much to the weight carried by the hunter into the forest or into the field.

FIG. 3 is another close up view of the attachment point of the straps of the integrated range finder. The straps can be attached to a belt, belt loop, jacket hasp or any other suitable attachment point preferably about hip level. This provides more than enough stability for the range finder apparatus.

FIG. 4 shows a rear view of the integrated range finder, including the shoulder attachment apparatus attached to the hunter's shoulder. The optimum configuration is comprised of the padded shoulder mount resting on either shoulder with the strap attached to the hunter's belt or jacket to hold the apparatus firmly in place. In this Figure, the range finder is in the “down” or “off” position. When the range finder is quickly and silently flipped upright with a minimum of motion, it is quickly energized and is immediately ready for use.

FIG. 5 is a front view of the integrated range finder with the range finder itself in the lowered (unactivated) position.

FIG. 6 shows the integrated range finder and shoulder mounting apparatus held in a hunter's hand.

### DETAILED DESCRIPTION OF THE INVENTION

The present invention is directed toward a silent, digital, adjustable, hands free Display Activation Apparatus and Method for Optical Viewing and associated shoulder attachment apparatus (hereinafter the integrated range finder) that a hunter can use with either a bow or a rifle. The silent, adjustable, hands free range finder and associated shoulder attachment apparatus allows a hunter to obtain continuous real time ranges to a target with a minimum of motion and noise while holding a rifle or bow in the ready to shoot position. The silent, adjustable, hands free range finder can be mounted on either shoulder depending on whether the hunter is left handed or right handed. For ease of understanding the present invention, the Optical Viewing Apparatus described herein will be a range finder, although any type of optical view device such as a scope or binoculars or a cell phone camera can be attached to the shoulder harness.

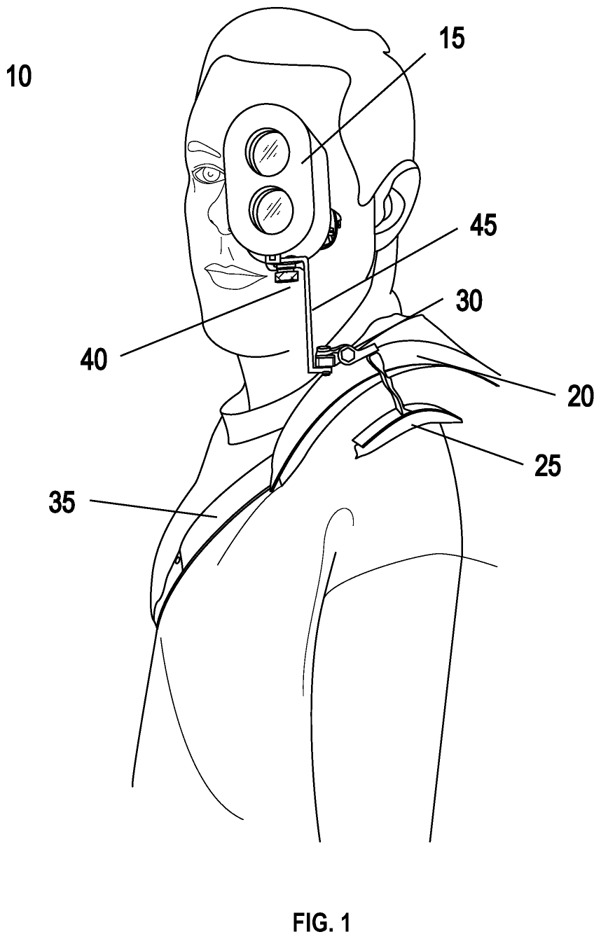

Referring to FIG. 1, the integrated range finder 10 is comprised of an optical viewing device 15, a shoulder mounting apparatus/bracket 45, one or more straps 35 to hold the upper portion 20 of the shoulder mounting apparatus securely to the shoulder, the optical viewing device attachment mechanism 40, the swivel mechanism 30, and the lower portion of the shoulder mounting apparatus 25. The range finder 15 is specially adapted with a switch to energize and de-energize the range finder. Battery life is generally a significant issue for range finders, so it important to incorporate a quick and easy way to energize and de-energize the range finder. This is especially important when a hunter can be in the field for many hours and would want the device to be available when needed. Alternatively, the range finder can be configured with a detent-related on-off mechanism such that the device is energized when it is in the upright position and de-energized when it is in the down or stored position. The device is a small item that is generally commercially available. Modifications may be made to the basic device to accommodate the needs of an individual hunter.

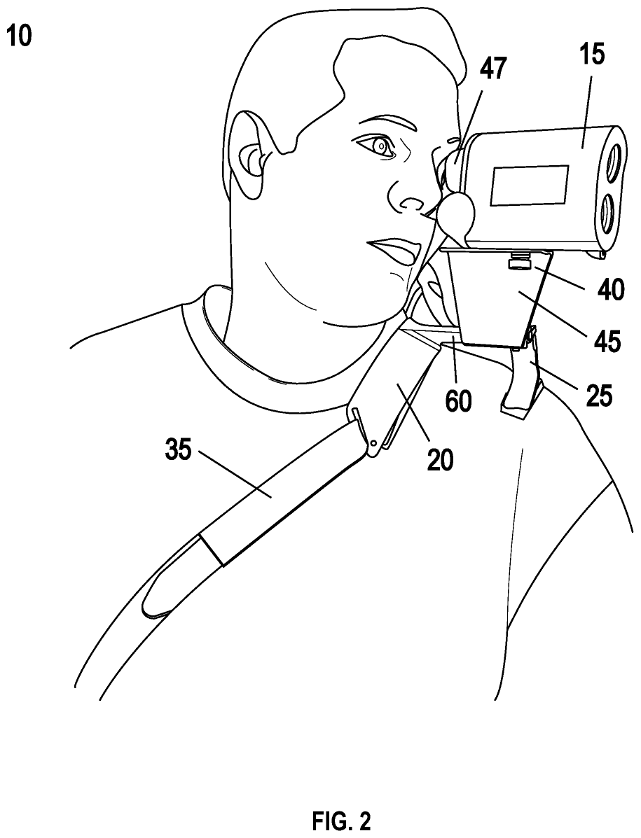

FIG. 2 presents a front view of the integrated range finder apparatus 10. This view shows the relative size of the combined apparatus. The small size is important to a hunter because it adds very little weight to the often considerable weight that a hunter must carry into the field or into the forest. The combined apparatus can typically be made of lightweight metals or composites. However, if greater strength and weight are desired, the components can be made of stainless steel or other similar materials.

FIG. 2 also shows the hunter with his/her head turned about 90 degrees to the left to look through the range finder. Included in this view are the eyepiece 47, the range finder itself 15, the bracket 45, the mechanical attachment device 40, the lower portion of the shoulder mount 25, the upper portion of the shoulder mount 20, and a spacer bar 60. The spacer bar may be of a fixed length or may be adjustable in order to better fit each individual hunter's shoulder.

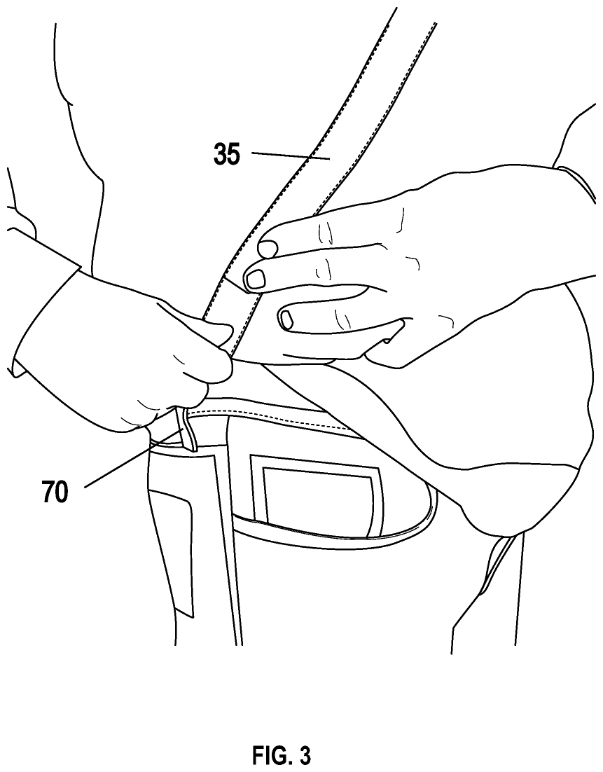

Referring to FIG. 3, the method of securely attaching the integrated range finder to the hunter's clothing is shown. This view shows the front strap 35 being attached to the hunter's belt loop 70. In general, there would be one or more rear straps that also attach to the hunter's clothing. The attachment can take several forms. The straps can be attached to a belt or belt loop with a mechanical means such as a carabiner or other type of clip. In an alternate mode, the straps can be affixed with a Velcro assembly or something similar.

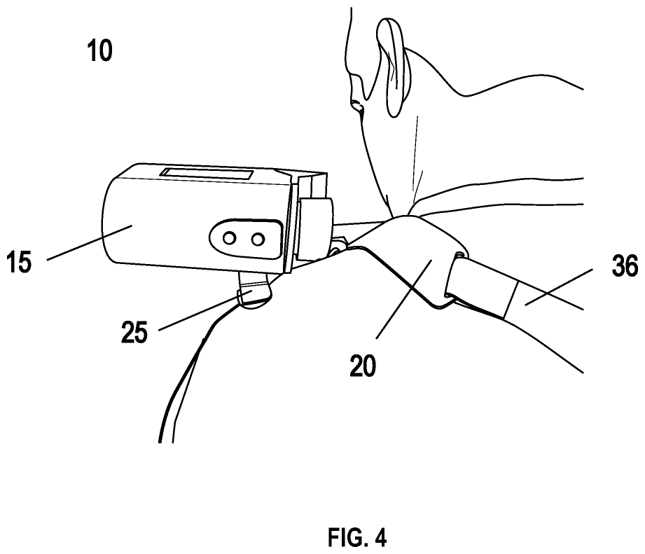

Referring to FIG. 4, a rear view of the integrated range finder 10 resting on the hunter's shoulder is shown. This view shows the range finder 15 in the down or unpowered position. Also shown is the rear strap 36, the upper portion of the shoulder mount 20 and the lower portion of the shoulder mount 25.

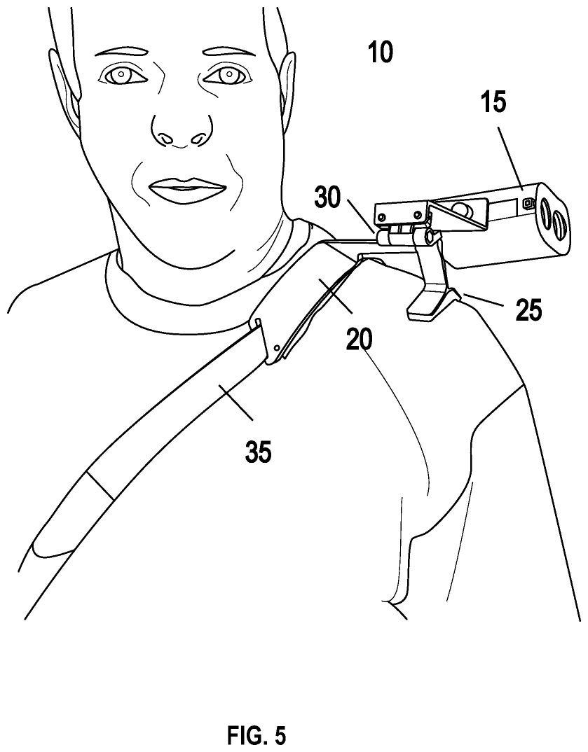

Referring to FIG. 5, a front view of the integrated range finder 10 is shown. This view allows for a clearer view of range finder itself in the down or unpowered position. Of particular interest in this view is the swivel 30 which allows the range finder itself to be moved from the down or unpowered position to the erect or powered position. The swivel may be a standard mechanical swivel made of metal or any other type of material that can facilitate quiet motion of the device around the swivel axis such as nylon.

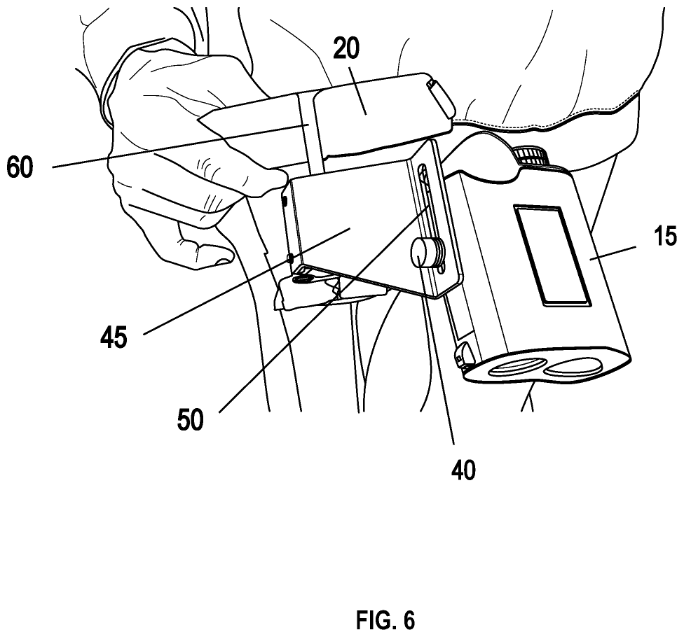

Referring to FIG. 6, the integrated range finder is shown in the hunter's hand in order to give a perspective of the overall size of the device. Also shown in this view is the slot 50 in the bracket 45 which allows the hunter to adjust the location of the range finder itself to the optimal distance from the hunter's eye. Also shown is the mechanical attachment device 40 which can be a screw and is loosened to allow movement along the slot 50.

FIGS. 1 through 6 and the associated discussion above present the best mode for making and practicing the invention. Alternate embodiments presented below would be available to enhance the overall apparatus.

One alternate variation of the improved invention is incorporation of an on/off continuous scan button for the range finder. This variation allows the hunter to quickly and quietly go in and out of continuous scan mode. Since continuous scan impacts battery life negatively, it should only be used when absolutely necessary. Therefore a quick and quiet on/off button is incorporated. An additional facet includes the ability to incorporate a video recorder, night vision device or infrared into the apparatus.

Another alternate variation is the modification of the shoulder apparatus such that a video camera can be mounted so that the hunter can capture the results of his or her hunt. The video camera can be mounted alone or it can be mounted along with the silent hands free range finder.

Another alternate variation includes use of at least one ball and socket apparatus to provide the required degrees of freedom of motion of the combined apparatus.

Another alternate variation includes the use of a GPS chip in the camera so that the hunter can record the exact position where a target was encountered or a shot was taken.

Another alternate variation comprises locating the switch to activate the range finder near the eyepiece so that the device can be activated/deactivated with slight pressure from the chin or side of the lower head. This allows for minimal movement on the part of the hunter and a significant reduction in noise from moving the hand or arm.

A further variation allows for the range finder to be detached from the shoulder harness and attached to another item such as a baseball cap or hunter's hat.

Another variation allows for the shoulder harness to modified so that the integrated range finder can be replaced with a scope, binoculars, camera or any other type of viewing device. This is done in instances where the range is less important than an actual clear view of the animal in question.

A further variation allows for voice or tap activation of the on/off function of the range finder in order to save batteries.

A further variation allows for an emergency notification feature to be included in the integrated range finder. This would be a voice or tap activated device included in the integrated range finder that would allow the hunter to notify friends and/or authorities if he or she has encountered a problem and can no longer safely and expeditiously egress from the hunting location.

The following is claimed:

1. A silent, adjustable, hands free display and activation apparatus with optional video capability comprising:
a. an optical viewing or recording device,
b. a bracket,
c. one or more straps,
d. an upper shoulder mount,
e. a lower shoulder mount,
f. a spacer connecting the upper shoulder mount to the lower shoulder mount,
g. a mechanism to affix the optical viewing or recording device to the bracket, and
h. a swivel mechanism.

2. The apparatus as in claim 1 where the straps hold the upper shoulder mount to a person's shoulder.

3. The apparatus as in claim 1 where the straps are affixed to a person's clothing to hold the apparatus firmly onto the person's shoulder.

4. The apparatus as in claim 1 further comprising a slot in bracket such that the optical viewing or recording device can be adjusted closer or farther away from a person's head.

5. The apparatus as in claim 1 where the swivel allows the optical viewing or recording device to be rotated silently approximately 90 degrees from the horizontal to the vertical position.

6. The apparatus as in claim 1 where the spacer can be adjusted to increase or decrease the positioning of the lower shoulder mount on a person's shoulder.

7. The apparatus as in claim 1 where the optical device is a range finder.

8. The apparatus as in claim 1 where the spacer, bracket and shoulder mounts are composed of lightweight materials to reduce the weight on the person's shoulder.

9. The apparatus as in claim 1 where the swivel is composed of nylon or other similar material so that it may be deployed noiselessly.

10. The apparatus as in claim 1 where the upper and lower shoulder brackets are padded.

11. The apparatus as in claim 1 further comprising an eyepiece attached to the display device.

12. The apparatus as in claim 1 where the display device can be configured such that the display device is powered off in the horizontal position and powered on in the vertical position in order to save battery power.

13. The apparatus as in claim 1 where the display device can be powered on and off manually or in automatic.

14. A method for practicing a silent, adjustable, hands free display and activation apparatus with optional video capability comprising:
a. placing the apparatus on either shoulder,
b. adjusting the location of the display apparatus to the optimal position,
c. maintaining the display device in the horizontal position until such time as a person desires to view a target
d. slowly rotating the display device to the vertical position and powering it on, and
e. turning the person's head approximately 90 degrees to view the target through the eyepiece.

15. The method of claim 15 where the display device is a range finder which allows the person to get an accurate range to the target.

16. The method of claim 15 where the person is a hunter and is in perfect position to slowly and silently raise a bow or rifle to aim at the target.

17. A silent, adjustable, hands free range finder apparatus with optional video capability comprising:
a. an optical viewing or recording device,
b. a bracket,
c. one or more straps,
d. an upper shoulder mount,
e. a lower shoulder mount,
f. a spacer connecting the upper shoulder mount to the lower shoulder mount,
g. a mechanism to affix the range finder or recording device to the bracket, and
h. a swivel mechanism.

18. A range finder apparatus as in claim 17 where the straps can be attached to a person's belt loop.

19. A range finder apparatus as in claim 17 where the range finder can be powered on and off with audible commands.

20. A range finder apparatus as in claim 17 where the apparatus contains a GPS device to accurately record the person's location.
